(19) United States
(12) Patent Application Publication
(10) Pub. No.: US 2022/0057869 A1
(43) Pub. Date: Feb. 24, 2022

(54) MOUSE DEVICE AND MOUSE CASING

(71) Applicant: DEXIN CORPORATION, NEW TAIPEI CITY (TW)

(72) Inventors: HO-LUNG LU, NEW TAIPEI CITY (TW); KUAN-LING CHEN, New Taipei City (TW)

(21) Appl. No.: 17/316,676

(22) Filed: May 10, 2021

(30) Foreign Application Priority Data
Aug. 19, 2020 (TW) 109128222

(51) Int. Cl. G06F 3/0354; F21V 33/00

(52) U.S. Cl. CPC G06F 3/03543; F21Y 2115/10; F21V 33/0052

(57) ABSTRACT

A mouse device and a mouse casing are provided. The mouse device includes an upper casing, a lower casing, a circuit board, and a light emitting element. The upper casing is disposed on the lower casing. Each of the upper casing and the lower casing has a plurality of hollow polygons of different sizes. The light emitting element is disposed on the circuit board. The circuit board and the light emitting element are arranged in an accommodating space between the upper casing and the lower casing.

### CROSS-REFERENCE TO RELATED PATENT APPLICATION

This application claims the benefit of priority to Taiwan Patent Application No. 109128222, filed on Aug. 19, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a mouse device and a mouse casing, and more particularly to a mouse device and a mouse casing that each has a hollow structure.

### BACKGROUND OF THE DISCLOSURE

A mouse device is a common peripheral device. The appearance of the conventional mouse device is getting more and more diverse, but the weight thereof is still fairly heavy. In addition, the conventional mouse device provides a less pleasurable visual experience than that provided by an RGB device, such as an RGB keyboard device.

Accordingly, providing a mouse device that has a lighter weight and a better visual effect has become one of the important issues to be addressed in the related field.

### SUMMARY OF THE DISCLOSURE

In response to the above-referenced technical inadequacies, the present disclosure provides a mouse device that includes an upper casing, a lower casing, a circuit board, and a light emitting element. The upper casing is disposed on the lower casing. Each of the upper casing and the lower casing has a plurality of hollow polygons of different sizes. The light emitting element is disposed on the circuit board. The circuit board and the light emitting element are disposed in an accommodating space that is located between the upper casing and the lower casing.

In another aspect, the present disclosure provides a mouse casing that includes an upper casing and a lower casing. The upper casing is disposed on the lower casing. Each of the upper casing and the lower casing has a plurality of hollow polygons of different sizes, which are irregularly arranged on the upper casing and the lower casing.

Therefore, one of the effects of the present disclosure is that each of the mouse device and the mouse casing provided by the present disclosure has the plurality of hollow triangles of different sizes on the casing, and through a cooperation of the light emitting element and the plurality of hollow triangles, the mouse device in use provides an enhanced visual effect. In addition, the mouse casing with the plurality of hollow triangles has a lighter weight, so that a user experience can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a mouse device according to a first embodiment of the present disclosure;

FIG. 2 is a schematic exploded view of the mouse device according to the first embodiment of the present disclosure;

FIG. 3 is a schematic view of a flanking unit and a first side wall of a main body unit according to the first embodiment of the present disclosure;

FIG. 4 is a schematic view of a mouse casing according to a second embodiment of the present disclosure;

FIG. 5 is a schematic exploded view of the mouse casing according to the second embodiment of the present disclosure; and

FIG. 6 is a schematic view of a flanking unit and a first side wall of a main body unit according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

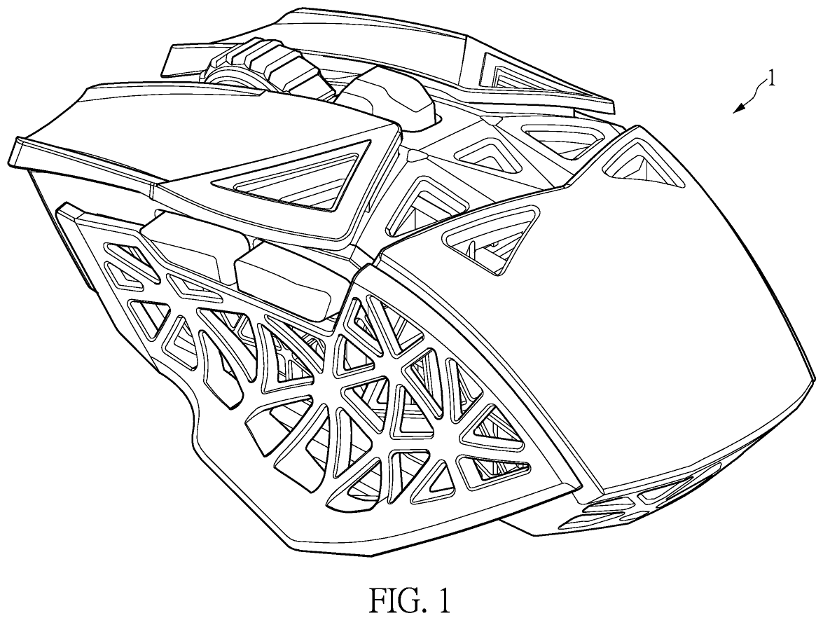

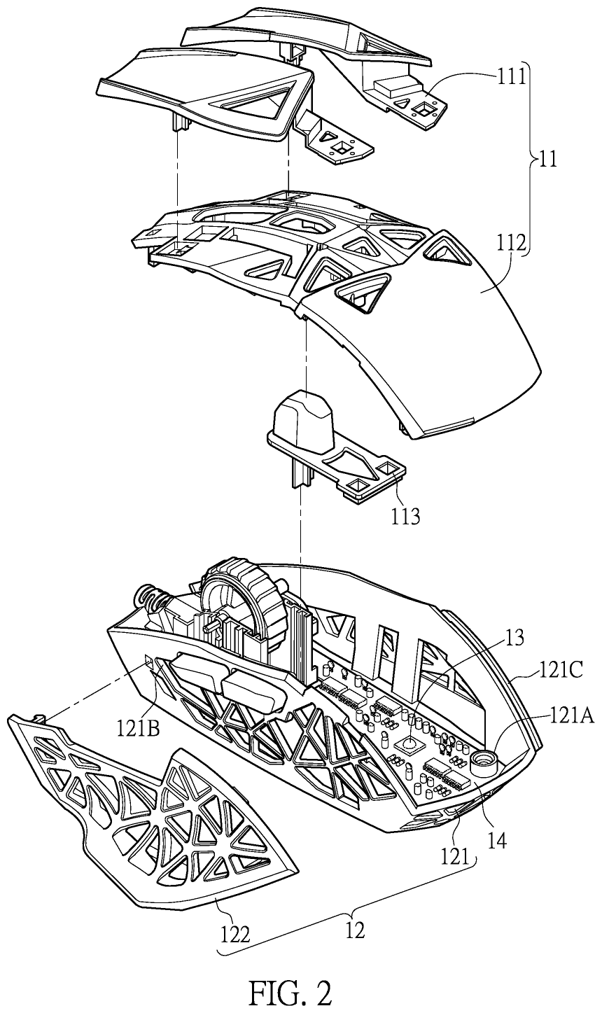

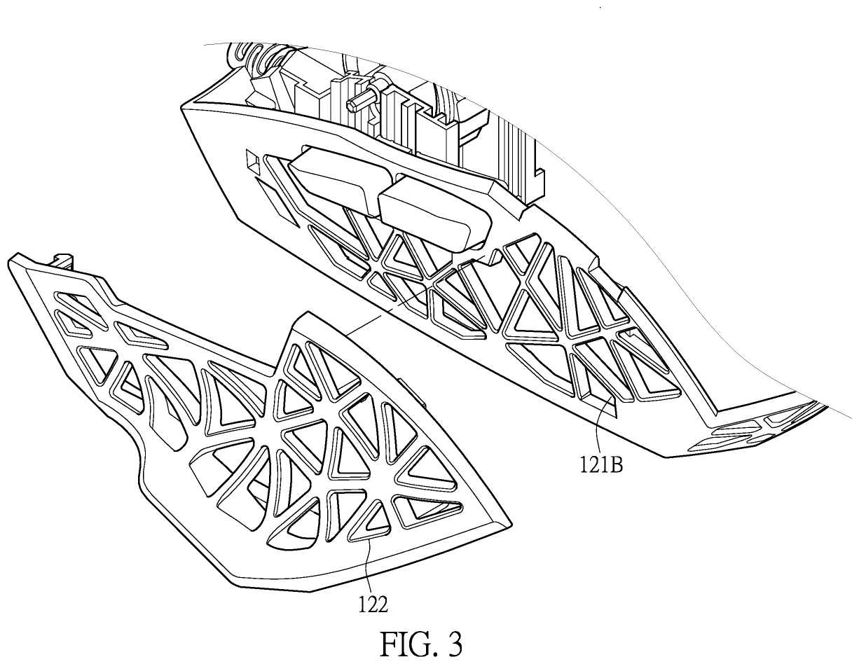

Referring to FIG. 1 to FIG. 3, FIG. 1 is a schematic view of a mouse device according to a first embodiment of the present disclosure, FIG. 2 is a schematic exploded view of the mouse device according to the first embodiment of the present disclosure, and FIG. 3 is a schematic view of a flanking unit and a first side wall of a main body unit according to the first embodiment of the present disclosure.

The mouse device 1 includes an upper casing 11, a lower casing 12, a circuit board 13, and a light emitting element 14.

The upper casing 11 is disposed on the lower casing 12, and each of the upper casing 11 and the lower casing 12 has a plurality of hollow polygons of different sizes. That is, components inside the mouse device 1 can be seen from outside. In addition, the light emitting element 14 is disposed on the circuit board 13. The circuit board 13 and the light emitting element 14 are disposed in an accommodating space that is located between the upper casing 11 and the lower casing 12. In the present embodiment, the hollow polygons included in each of the upper casing 11 and the lower casing 12 are hollow triangles. In another embodiment, the hollow polygons can be a triangle, a rhombus with rounded corners, a rectangle, a pentagon, a pentagram, or a hexagram.

In addition, the mouse device 1 further includes a power supply module (not shown in figures) that is electrically connected to the circuit board 13 and the light emitting element 14 to provide an electrical energy.

That is, the light emitting element 14 can be powered through a control module (not shown in figures) and the power supply module (not shown in figures) of the circuit board 13 to emit a light. In addition, the light emitting element 14 can be a light-emitting diode (LED), an organic light-emitting diode (OLED), an LED array, or an OLED array. The light emitted by the light emitting element 14 can be of a white color, a red color, a green color, a blue color, an orange color, a light having a variety of colors, or a light having changeable colors.

As mentioned above, the light emitted by the light emitting element 14 of the mouse device 1 can pass out of the mouse device 1 through a plurality of hollow triangles of each of the upper casing 11 and the lower casing 12, so as to provide users with a better visual experience.

The upper casing 11 includes a first casing unit 111 and a second casing unit 112. The first casing unit 111 is fixedly connected to the second casing unit 112. In the present embodiment, the first casing unit 111 and the second casing unit 112 are arranged on a front side and a rear side of the mouse device 1, respectively. In addition, each of the first casing unit 111 and the second casing unit 112 is a curved panel body. Furthermore, each of the first casing unit 111 and the second casing unit 112 can also have the plurality of hollow triangles of different sizes. In the present embodiment, the hollow triangle can be a hollow triangle arranged on a flat or curved surface. In the present embodiment, a shape of the hollow polygon included in each of the upper casing 11 and the lower casing 12 can be a trapezium, a rhombus with rounded corners, a square, a triangle, a pentagon, a polygon, etc., but it is not limited in the present disclosure. In addition, the hollow polygons can be a hollow polygon arranged on the flat or curved surface. The hollow polygons included in each of the upper casing 11 and the lower casing 12 can have a combination of various polygons or only a single polygon, but it is not limited in the present disclosure.

The upper casing 11 can further include a fixing unit 113 which is fixedly connected to the first casing unit 111 and the second casing unit 112. That is, the first casing unit 111 is fixedly connected to the second casing unit 112 through the fixing unit 113.

The lower casing 12 includes the main body unit 121 and the flanking unit 122. The main body unit 121 has a base plate 121A, a first side wall 121B, and a second side wall 121C. The first side wall 121B and the second side wall 121C are arranged on opposite sides of the base plate 121A. Each of the first side wall 121B and the second side wall 121C can have the plurality of hollow triangles of different sizes. The flanking unit 122 at least has a curved panel body. The curved panel body of the flanking unit 122 has the plurality of hollow triangles of different sizes. A main reason for the design of the flanking unit 122 to be in the shape of the curved panel body is to match with a curvature of a human hand when holding a mouse.

The flanking unit 122 is detachably arranged on a side of the first side wall 121B of the main body unit 121 or a side of the second side wall 121C of the main body unit 121. In the present embodiment, the flanking unit 122 is arranged on the side of the first side wall 121B of the main body unit 121 (thus being suitable for a right-handed user). In another embodiment, the flanking unit 122 can be arranged on the side of the second side wall 121C of the main body unit 121 (thus being suitable for a left-handed user).

When the flanking unit 122 is arranged on the side of the first side wall 121B of the main body unit 121 or the side of the second side wall 121C of the main body unit 121, a predetermined distance is defined between the flanking unit 122 and the first side wall 121B of the main body unit 121 or the second side wall 121C of the main body 121. That is, a large gap exists between the flanking unit 122 and main body unit 121. In this way, when the light from the light emitting element 14 passes through the plurality of hollow triangles of the main body unit 121 and the plurality of hollow triangles of the flanking unit 122, the light changes in a more diverse manner.

### Second Embodiment

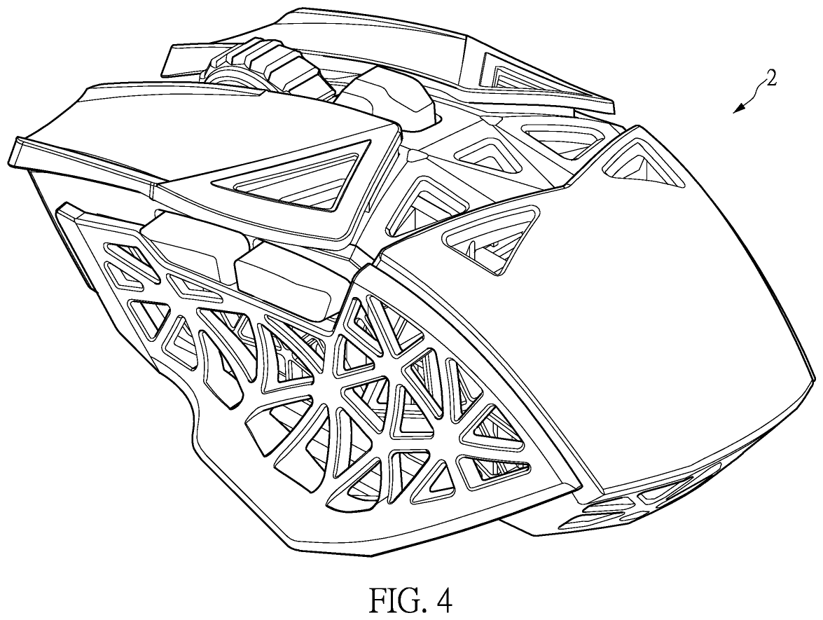

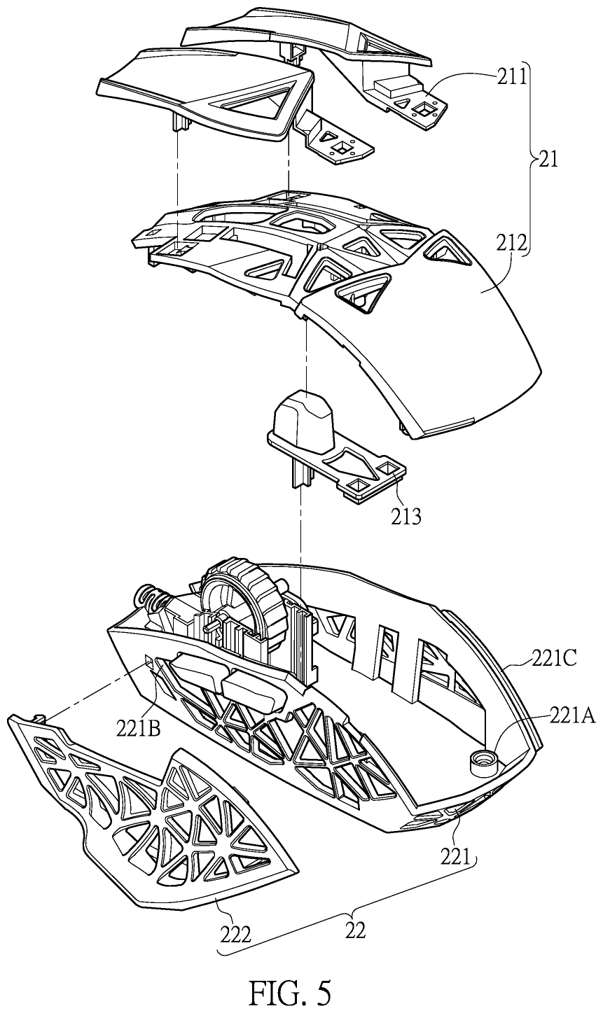

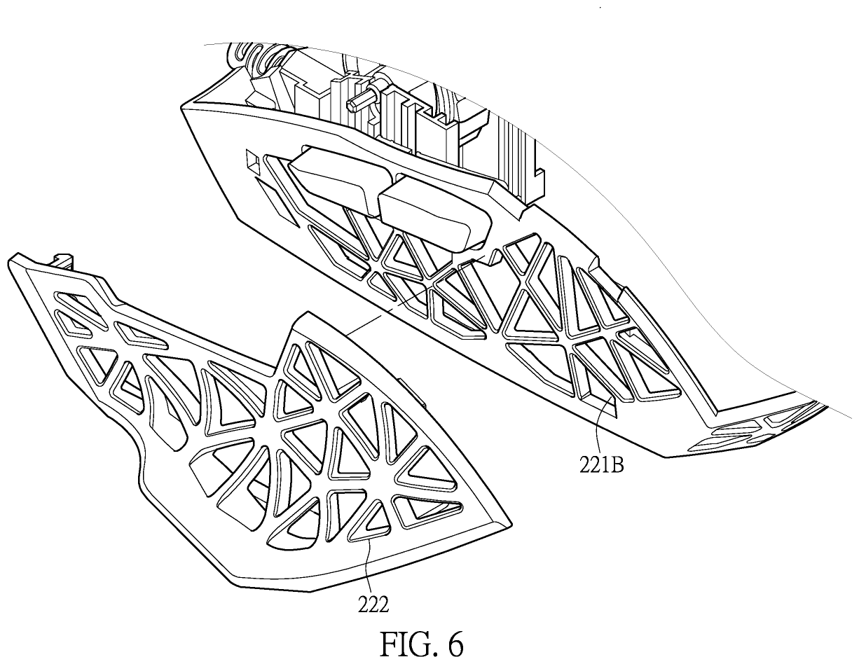

Referring to FIG. 4 to FIG. 6, FIG. 4 is a schematic view of a mouse casing according to a second embodiment of the present disclosure, FIG. 5 is a schematic exploded view of the mouse casing according to the second embodiment of the present disclosure, and FIG. 6 is a schematic view of a flanking unit and a first side wall of a main body unit according to the second embodiment of the present disclosure.

The mouse casing 2 includes an upper casing 21 and a lower casing 22. The upper casing 21 is disposed on the lower casing 22.

Each of the upper casing 21 and the lower casing 22 has a plurality of hollow triangles of different sizes. That is, an inside of the mouse casing 2 is visible from outside. The plurality of hollow triangles are irregularly arranged on the upper casing 21 and the lower casing 22.

The upper casing 21 includes a first casing unit 211 and a second casing unit 212. The first casing unit 211 is fixedly connected to the second casing unit 212. In addition, each of the first casing unit 211 and the second casing unit 212 can also have the plurality of hollow triangles of different sizes. In the present embodiment, the hollow triangle can be a hollow triangle arranged on a flat or curved surface.

Further, the upper casing 21 includes a fixing unit 213 which is fixedly connected to the first casing unit 211 and the second casing unit 212. That is, the first casing unit 211 is fixedly connected to the second casing unit 212 through the fixing unit 213.

The lower casing 22 includes the main body unit 221 and the flanking unit 222. The main body unit 221 has a base plate 221A, the first side wall 221B, and a second side wall 221C. The first side wall 221B and the second side wall 221C are arranged on opposite sides of the base plate 221A. Each of the first side wall 221B and the second side wall 221C of the main body unit 221 can have the plurality of hollow triangles of different sizes. The flanking unit 222 at least has a curved panel body. The curved panel body of the flanking unit 222 has the plurality of hollow triangles of different sizes. A main reason for the design of the flanking unit 122 to be in the shape of the curved panel body with a curved surface is to match with a curvature of a human hand when holding a mouse. In the present embodiment, the hollow polygon included in each of the upper casing 21 and the lower casing 22 can be the hollow triangle. In another embodiment, the hollow polygon can be a triangle, a rhombus with rounded corners, a square, a pentagon, a pentagram, or a hexagram.

The flanking unit 222 is detachably arranged on a side of the first side wall 221B of the main body unit 221 or a side of the second side wall 221C of the main body unit 221. In the present embodiment, the flanking unit 222 is arranged on the side of the first side wall 221B of the main body unit 221 (thus being suitable for a right-handed user). In another embodiment, the flanking unit 222 can be arranged on the side of the second side wall 221C of the main body unit 221 (thus being suitable for a left-handed user).

When the flanking unit 222 is arranged on the side of the first side wall 221B of the main body unit 221 or the side of the second side wall 221C of the main body unit 221, the flanking unit 222 has a predetermined distance that is defined between the flanking unit 222 and the first side wall 221B of the main body unit 221 or the second side wall 221C of the main body unit 221. That is, a large gap exists between the flanking unit 222 and main body unit 221.

### Beneficial Effects of the Embodiments

In conclusion, one of the effects of the present disclosure is that each of the mouse device and the mouse casing provided by the present disclosure has the plurality of hollow triangles of different sizes on the casing, and through a cooperation of the light emitting element and the plurality of hollow triangles, the mouse device in use provides an enhanced visual effect. In addition, the mouse casing with the plurality of hollow triangles has a lighter weight, so that a user experience can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A mouse device, comprising:
an upper casing;
a lower casing, the upper casing being disposed on the lower casing, each of the upper casing and the lower casing having a plurality of hollow polygons of different sizes;
a circuit board; and
a light emitting element disposed on the circuit board, the circuit board and the light emitting element being disposed in an accommodating space that is located between the upper casing and the lower casing.

2. The mouse device according to claim 1, wherein the upper casing includes a first casing unit and a second casing unit, the first casing unit is fixedly connected to the second casing unit, each of the first casing unit and the second casing unit has a curved panel body, and each of the first casing unit and the second casing unit has the plurality of hollow polygons of different sizes.

3. The mouse device according to claim 2, wherein the upper casing further includes a fixing unit, the first casing unit being fixedly connected to the second casing unit through the fixing unit.

4. The mouse device according to claim 1, wherein the lower casing includes a main body unit and a flanking unit, the main body unit having a base plate, a first side wall, and a second side wall, the first side wall and the second side wall being arranged on opposite sides of the base plate, and wherein each of the first side wall of the main body unit and the second side wall of the main body unit has the plurality of hollow polygons of different sizes, the flanking unit at least has the curved panel body, and the curved panel body of the flanking unit has the plurality of hollow polygons of different sizes.

5. The mouse device according to claim 4, wherein the flanking unit is detachably arranged on a side of the first side wall of the main body unit or a side of the second side wall of the main body unit, and wherein, when the flanking unit is arranged on the side of the first side wall of the main body unit or the side of the second side wall of the main body unit, a predetermined distance is defined between the flanking unit and the first side wall of the main body unit or the second side wall of the main body unit.

6. The mouse device according to claim 1, wherein the light emitting element is a light-emitting diode unit or an organic light-emitting diode unit.

7. A mouse casing, comprising:
an upper casing; and
a lower casing, the upper casing being disposed on the lower casing, each of the upper casing and the lower casing having a plurality of hollow polygons of different sizes, the plurality of hollow polygons being irregularly arranged on the upper casing and the lower casing.

8. The mouse casing according to claim 7, wherein the upper casing includes a first casing unit and a second casing unit, the first casing unit is fixedly connected to the second casing unit, each of the first casing unit and the second casing unit has a curved panel body, and each of the first casing unit and the second casing unit has the plurality of hollow polygons of different sizes.

9. The mouse casing according to claim 8, wherein the upper casing further includes a fixing unit, the first casing unit being fixedly connected to the second casing unit through the fixing unit.

10. The mouse casing according to claim 7, wherein the lower casing includes a main body unit and a flanking unit, the main body unit having a base plate, a first side wall, and a second side wall, the first side wall and the second side wall being arranged on opposite sides of the base plate, and wherein each of the first side wall of the main body unit and the second side wall of the main body unit has the plurality of hollow polygons of different sizes, the flanking unit at least has the curved panel body, and the curved panel body of the flanking unit has the plurality of hollow polygons of different sizes.

11. The mouse casing according to claim 10, wherein the flanking unit is detachably arranged on a side of the first side wall of the main body unit or a side of the second side wall of the main body unit, and wherein, when the flanking unit is arranged on the side of the first side wall of the main body unit or the side of the second side wall of the main body unit, a predetermined distance is defined between the flanking unit and the first side wall of the main body unit or the second side wall of the main body unit.
